(19) United States
(12) Patent Application Publication
(10) Pub. No.: US 2008/0158672 A1
(43) Pub. Date: Jul. 3, 2008

(54) Method and Apparatus for Three Dimensional Imaging

(75) Inventor: Darren T. McCosky, McKinney, TX (US)

Correspondence Address: TEXAS INSTRUMENTS INCORPORATED, P O BOX 655474, M/S 3999, DALLAS, TX, 75265, US

(73) Assignee: TEXAS INSTRUMENTS INCORPORATED, Dallas, TX (US)

(21) Appl. No.: 11/618,063

(22) Filed: Dec. 29, 2006

(51) Int. Cl. G02B 27/22

(52) U.S. Cl. 359/464; 359/462

(57) ABSTRACT

A display generates a three dimensional image by generating light from light sources having a first set of wavelengths to produce left eye images and generating light from light sources having a second set of wavelengths, different from the first set of wavelengths, to produce right eye images. The left eye images and right eye images are received by the viewer through a pair of lenses, where a left eye lens passes the first set of wavelengths and blocks the second set of wavelengths and the right eye lens passes the second set of wavelengths and blocks the first set of wavelengths.

### CROSS-REFERENCE TO RELATED APPLICATIONS

Not Applicable

### STATEMENT OF FEDERALLY SPONSORED RESEARCH OR DEVELOPMENT

Not Applicable

### BACKGROUND OF THE INVENTION

1. Technical Field

This invention relates in general to imaging display systems and, more particularly, to a three dimensional imaging display.

2. Description of the Related Art

While three dimensional (or stereoscopic) video has been available for many decades, only recently has high quality three dimensional video been attainable. Early attempts at three dimension video used anaglyph images, where the image intended for one eye (generally the right eye) is printed through a red filter and the slightly different image intended for the other eye is printed through another color such as blue or cyan. The viewer wears glasses with a red lens on the left eye and a blue (or cyan) lens on the right eye. When viewed through the glasses, red is filtered out by the red lens, while the blue appears dark, and blue is filtered out by the blue lens, while red appears dark. Hence, two slightly different images are received by the right and left eyes, providing the stereoscopic effect.

While anaglyph images provide a three dimensional effect, they have serious shortcomings. First, the separation of the left and right images is crude, resulting in a sometimes poor three dimensional effect. Second, when used in conjunction a normal display device, such as a television or computer monitor, variations in display color can result in less than perfect filtering by the lenses, such that each eye sees part of the image intended for the other. Third, images received by the left and right eye are significantly different in color, and the viewer's brain must merge the two colors.

Modern day technology has provided improvements to the anaglyph system described above. A popular system for viewing movies uses polarized lenses—the left lens is polarized in a first direction and the right lens is polarized in a second direction orthogonal to the first direction. First and second projectors provide images with light polarized in the first and second directions, respectively. Accordingly, the left lens filters out all light from the second projector and the right lens filters out all light from the first projector. The stereoscopic effect from polarized lenses is quite good, but it requires specialized hardware at the source (i.e., two projectors), and therefore is not an acceptable system for television or computer gaming.

A similar attempt at three dimensional video is a headmount display, which uses a headset with individual displays in front of each eye. This is a pure form of stereoscopic imaging, since each eye sees only the display in front of it. However, this requires expensive equipment for each viewer (as opposed to the previously described solutions which require only relatively inexpensive glasses). Further, viewers often suffer eye fatigue after using the headset for a short while.

The most recent attempt at three dimension imaging uses alternating field technology; the left and right lenses alternately pass light to the viewers eyes as the display alternately generates left and right images. Typically, the lenses use LCD (liquid crystal display) technology to pass or block light. These devices are popular since they can be used with any output device so long as they can be synchronized with the changing of the images. Unfortunately, this solution has significant drawbacks as well. First, the glasses are relatively expensive, although not as expensive as a dual display headset. Second, synchronization is not possible with all technologies, and a given pair of alternating field glasses generally will work with only certain output devices based on the refresh rate. Third, the LCD mechanism is not instantaneous; the persistence of the LCD will cause cross-talk since one lens will not be fully closed before the other lens is fully open. Thus, at times, both eyes will receive an image intended for only one of the eyes.

Therefore, a need has arisen for an improved method and apparatus for providing three dimensional video.

### BRIEF SUMMARY OF THE INVENTION

In the present invention, a three dimensional image is produced by generating light from light sources having a first set of wavelengths to produce left eye images and generating light from light sources having a second set of wavelengths different from the first set of wavelengths to produce right eye images. The left eye images and right eye images are received by the viewer through a pair of lenses, where a left eye lens passes the first set of wavelengths and blocks the second set of wavelengths and the right eye lens passes the second set of wavelengths and blocks the first set of wavelengths.

The present invention provides significant advantages over the prior art. First, the three dimensional images produced by the present invention should be high quality with little crosstalk. Second, the lenses that separate the left and right images should be similar in size and weight to normal glasses and, therefore, comfortable to wear for extended periods. The lenses can be placed over normal prescription eyewear as well. Third, the lenses can be made using existing technology and should be relatively inexpensive with mass production. Fourth, the general design of the display device can be almost the same as existing devices, with the addition of a second set of light sources. Fifth, the system could be made compatible with existing three dimensional videos using alternating field technology. Sixth, the display system is capable of displaying 3D video at lower frame rates than other 3D systems, with less flicker. Seventh, the display device is completely compatible with normal two dimensional video. Eighth, the left and right images can be color corrected by desaturating the color points.

### BRIEF DESCRIPTION OF THE SEVERAL VIEWS OF THE DRAWINGS

For a more complete understanding of the present invention, and the advantages thereof, reference is now made to the following descriptions taken in conjunction with the accompanying drawings, in which:

FIG. 1 illustrates a simplified block diagram of the present invention;

FIG. 2 illustrates a right/left wavelength separation for two sets of primary colors for producing a color gamut;

FIGS. 3a and 3b illustrate a first embodiment for a pair of lens to selectively pass only one set of primary colors through each lens;

FIGS. 4a and 4b illustrate a second embodiment for a pair of lens to selectively pass only one set of primary colors through each lens;

FIGS. 5a and 5b illustrate a third embodiment for a pair of lens to selectively pass only one set of primary colors through each lens;

FIG. 6 illustrates a CIE 1931 color space chart with the left and right eye color spaces;

FIG. 7 illustrates an embodiment of the display system that can be used to show different video streams to different viewers using a single display.

### DETAILED DESCRIPTION OF THE INVENTION

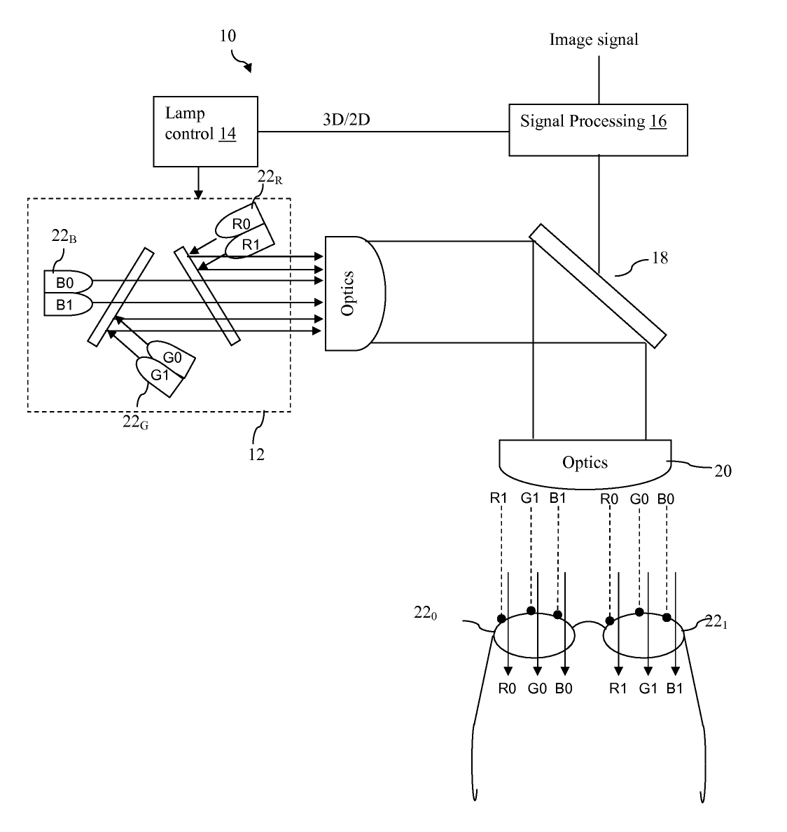

The present invention is best understood in relation to FIGS. 1-5a-b of the drawings, like numerals being used for like elements of the various drawings.

FIG. 1 illustrates a general block diagram of the present invention. A display 10 includes a light source subsystem 12 controlled by lamp control circuitry 14. An image signal is received by signal processing circuitry 16. Signal processing controls a spatial light modulator (SLM) 18 and supplies a 3D/2D signal to lamp control 14, indicating whether the image signal is a three dimensional image signal, with successive frames intended to alternate between the viewer's left and right eyes, or a two dimensional signal, where all frames are directed to both eyes. The light source subsystem 12 illuminates the SLM 18, which has individual elements to reflect light towards or away from optics 20. Optics 20 focuses the light for display. The particular order of R, G and B shown in FIG. 1 could be changed, if desired.

The light source subsystem 12 uses different sets of primary colors, slightly offset from one another, to illuminate the SLM 18. In the example shown in FIG. 1, red (R), green (G) and blue (B) are used to provide colored light to the SLM 18. For frames intended for the left eye, individual light sources output the primary colors at wavelengths R0, G0 and B0. For frames intended for the right eye, individual light sources output colors at wavelengths R1, G1 and B1. To see a three dimensional image, the viewer wears lenses 22 over his or her eyes. The left lens 22₀ passes light at wavelengths R0, G0 and B0 and blocks light at wavelengths R1, G1, and B1. Similarly, the right lens 22₁ passes light at wavelengths R1, G1 and B1 and blocks light at wavelengths R0, G0, and B0.

The light source subsystem 12 could use a variety of devices to produce the two sets of primary colors. In one embodiment, color-tuned, narrow-band, light emitting diode (LED) arrays 22 (individually reference as LED arrays 22_{R}, 22_{G} and 22_{B}) are used as shown in FIG. 1, where each array is operable to illuminate the SLM in one of the two paired colors (R0/R1, G0/G1 and B0/B1). Color tuned lasers could also be used as the light sources and, because of the more precise wavelength of laser light, could be preferable over an LED. A single laser (for each of the three or more colors) could be tuned or modulated on the fly to produce the bimodal color required, which would reduce space and preserve the source etendue. Alternatively, a traditional light source with a color wheel could be used, where the color wheel has slices for R0, R1, G0, G1, B0 and B1.

SLM 18 may be any type of SLM, such as a digital micromirror device (DMD). Other types of SLMs could be substituted into display 10 and used for the invention described herein. For example, SLM 16 could be an LCD-type SLM having addressable pixel elements. Details of a suitable SLM 18 are set out, for example, in U.S. Pat. No. 4,956,619, entitled “Spatial Light Modulator”, which is assigned to Texas Instruments Incorporated, and incorporated by reference herein.

FIG. 1 illustrates a very basic implementation of a DMD-based digital display. A comprehensive description of a DMD-based digital display system is set out in U.S. Pat. No. 5,079,544, entitled “Standard Independent Digitized Video System”, and in U.S. Pat. No. 5,526,051, entitled “Digital Television System”, and in U.S. Pat. No. 5,452,024, entitled “DMD Display System”, each assigned to Texas Instruments Incorporated, and each incorporated by reference herein. U.S. Pat. No. 5,278,652, entitled “DMD Architecture and Timing for Use in a Pulse-Width Modulated Display System”, describes a method a formatting video data for use with a DMD-based display system and a method of modulating bit-planes of data to provide varying pixel brightness. The general use of a DMD-based display with LEDs is described in U.S. Pub. Nos. 2006/0044520 and 2006/0044952, which are incorporated by reference herein. The general use of a DMD-based display system with a color wheel to provide sequential color images is described in U.S. Pat. No. 5,233,385, entitled “White Light Enhanced Color Field Sequential Projection”. These patent applications are assigned to Texas Instruments Incorporated, and are incorporated herein by reference.

In operation, each set of primary wavelengths is capable of producing an acceptable color gamut at each eye. Hence each eye receives a full color image, as it would if the eye was focused on a normal monitor. However, the left eye and the right eye only receive the images intended for that eye.

When in a three dimensional mode, the image signal received by signal processing 16 includes alternating left and right images. When the SLM 18 is set to reflect light for a frame intended for the left eye, lamp control 14 uses the appropriate one of the left eye light sources; i.e., R0, G0 or B0, to illuminate the SLM 18. Similarly, when the SLM 18 is set to reflect light for a frame intended for the right eye, lamp control 14 uses the appropriate one of the right eye light sources; i.e., R1, G1 or B1, to illuminate the SLM 18. Frames displayed using R0, G0 and B0 will pass through lens 22₀ and be blocked at lens 22₁. Frames displayed using R1, G1 and B1 will pass through lens 22₁ and be blocked at lens 22₀.

In a normal 2D mode, the SLM 18 would reflect light for one frame at a time, in sequence, using pulse width modulation techniques. The pulse width modulation is accomplished by delivering pixel data to the SLM 18 in a “bit-plane” format, described in U.S. Pat. No. 5,278,652, referenced above. The bit-plane format arranges the data for each frame (separated by color) according to bit weights. Using a binary weighting system, for a standard time unit T, bit-plane “0” will selectively control the SLM 18 for time T, bit-plane “1” will selectively control the SLM 18 for time 2T, bit-plane “2” will control the SLM 18 for 4T, and so on. It should be noted that weighting systems other than a binary weighting system can be used, and times for longer bit planes may be split to avoid artifacts. Also, the bit-planes are not necessarily shown in displayed in order—i.e., bit-plane “0” could be displayed between bit-plane “1” and bit-plane “3”.

In 3D mode, however, sequential images are preferably displayed concurrently, if using a light source technology such as LEDs or lasers that can switch on and off quickly. Thus, for a arbitrary frame x intended for the left eye, the order of controlling the SLM 18, for a specific color, could be: bit-plane “0” of frame x, bit-plane “0” of frame x+1 (intended for the right eye), bit-plane “1” of frame x, bit-plane “1” of frame x+1, bit-plane “2” of frame x, bit-plane “2” of frame x+1. Displaying successive frames concurrently by alternating the bit-planes of successive frames, eliminates or greatly reduces flicker. This may allow for lower frame rates than are necessary for other 3D display systems.

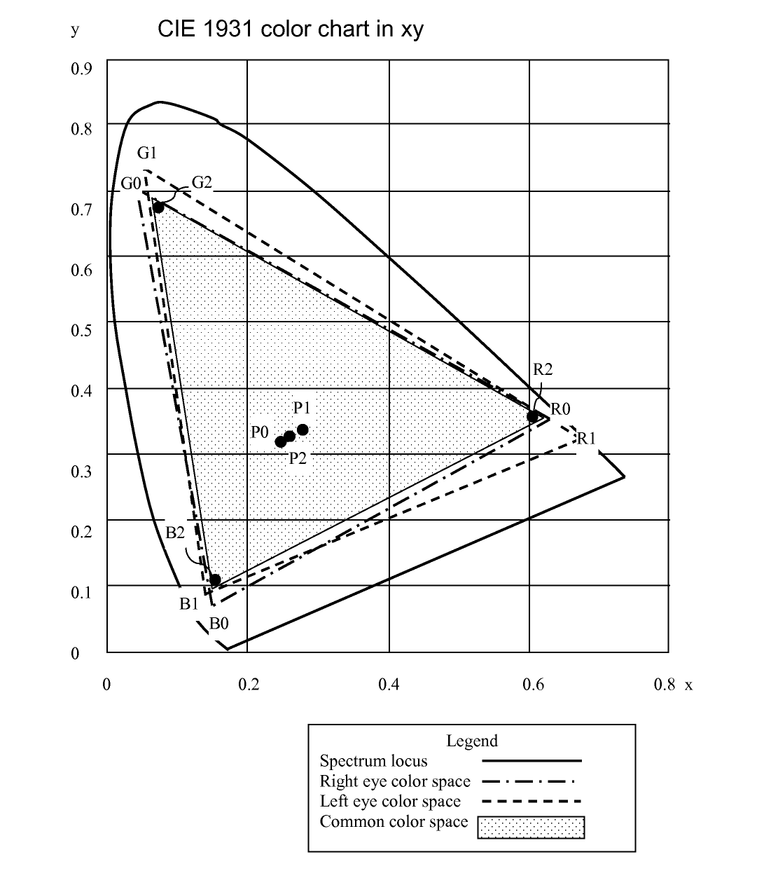

Because the primary light wavelengths used to create the image are slightly different depending upon which eye is receiving the image, identical video frames may have a very slight color shift depending on the eye to which they are directed. Signal processing 16 can compensate for the slight color shift by adjusting the modulation at the SLM 18 based on which set of wavelengths is being used. It is expected, however, that the unadjusted shift is so slight as to be unnoticeable by the viewer. Color matching the left and right images is discussed in greater detail in connection with FIG. 6.

In mono (2D) mode, any set of primary color light sources could be used to produce the color gamut for the video display. Either the left eye color wavelengths (R0, G0 and B0) or right eye color wavelengths (R1, G1 and B1) could be used, or a combination (R0, G1 and B1, for example), or both light sources of the same primary color could be used simultaneously for one or more of the colors. The set of light sources used for the primary colors could be periodically changed in order to extend the life of the light sources.

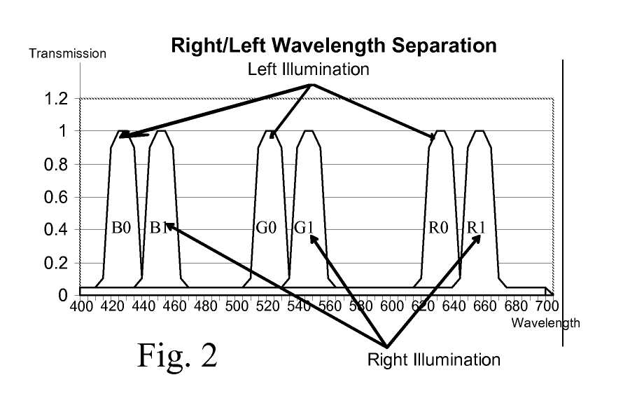

FIG. 2 illustrates an example of the right/left wavelength separation. It should be noted that the wavelengths shown in FIG. 2 are just examples, and other sets of wavelengths could be chose for an actual implementation.

In FIG. 2, the left eye wavelengths are centered at approximately B0=430 nm, G0=525 nm and R0=630 nm and the right eye wavelengths are centered at approximately B1=450 nm, G1=545 nm and R1=650 nm. As shown in FIG. 2, the LEDs emit light on either side of the centerline. Lasers, on the other hand, can emit light in a much smaller bandwidth ant he offset between the different sets of wavelengths can be reduced.

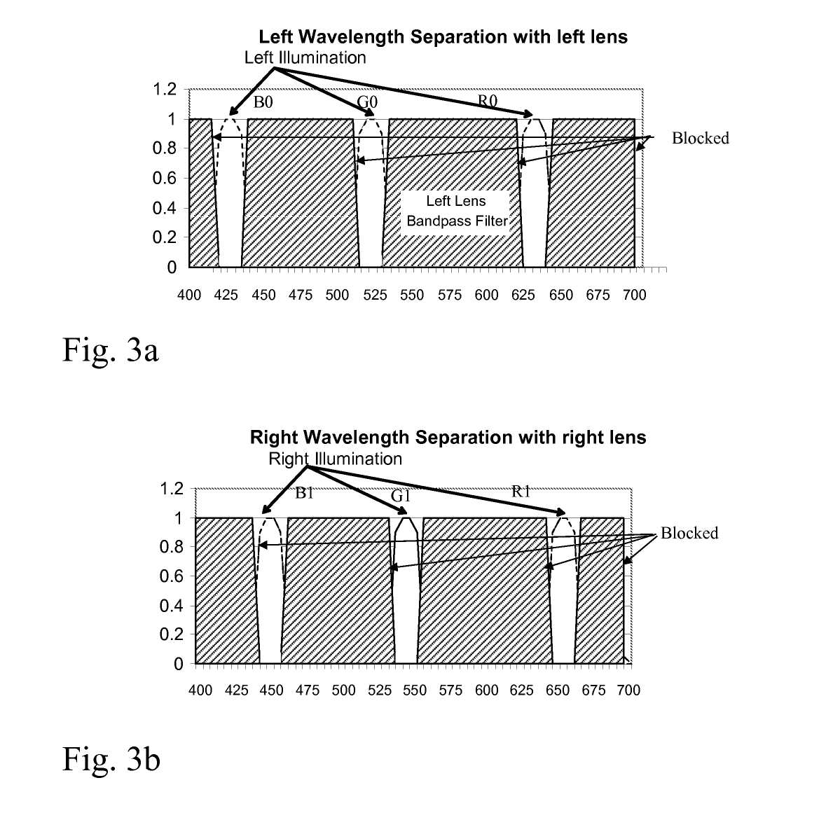

FIGS. 3a and 3b illustrate a first embodiment for selectively blocking light wavelengths in the left and right lenses 22₀ and 22₁. In FIG. 3a, the left lens 22₀ blocks all wavelengths other than a bandwidth of approximately 20 nm centered around R0, B0 and G0. Similarly, in FIG. 3b, the right lens 22₁ blocks all wavelengths other than a bandwidth of approximately 20 nm centered around R1, B1 and G1.

Optical materials which provide bandpass filters for passing multiple discrete wavelengths, while blocking others, is available, for example, from SEMROCK of Rochester, N.Y.

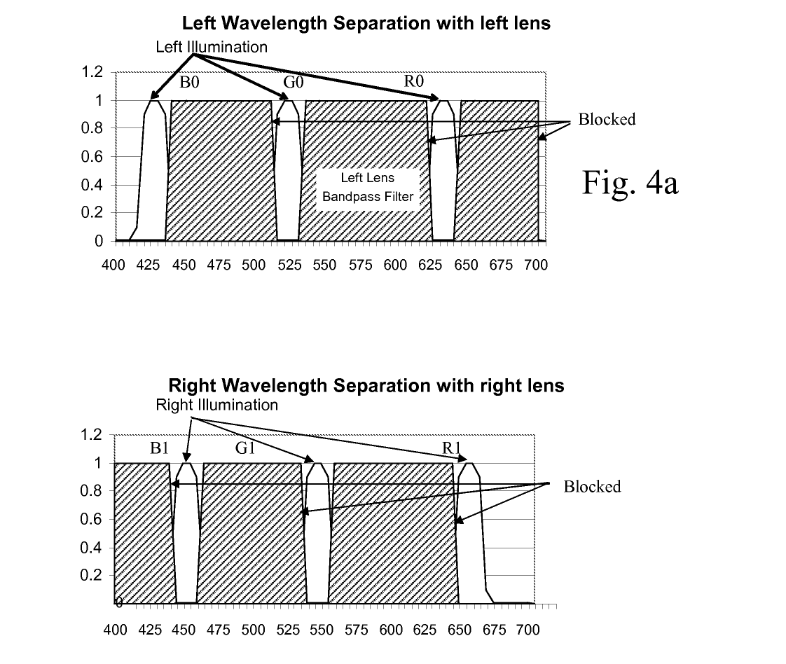

FIGS. 4a and 4b illustrate a second embodiment for selectively blocking light wavelengths in the left and right lenses 22₀ and 22₁. In this embodiment, as shown in FIG. 4a, wavelengths up to approximately 440 nm are passed by lens 22₀. Lens 22₀ also provides a bandpass filter at G0 and R0 (±approximately 10 nm), while blocking all other wavelengths above 440 nm. Similarly, in FIG. 4b, wavelengths above approximately 440 nm are passed by lens 22₀. Lens 22₀ also provides a bandpass filter at B1 and G1 (±approximately 10 nm), while blocking all other wavelength below 640 nm.

The embodiment shown in FIGS. 4a and 4b simplifies the fabrication of lenses 22, since only three wavelength ranges are filtered, rather than four ranges in FIGS. 3a and 3b. This is accomplished by passing wavelengths on the ends of the spectrum which are not used by the light sources associated with the opposite lens.

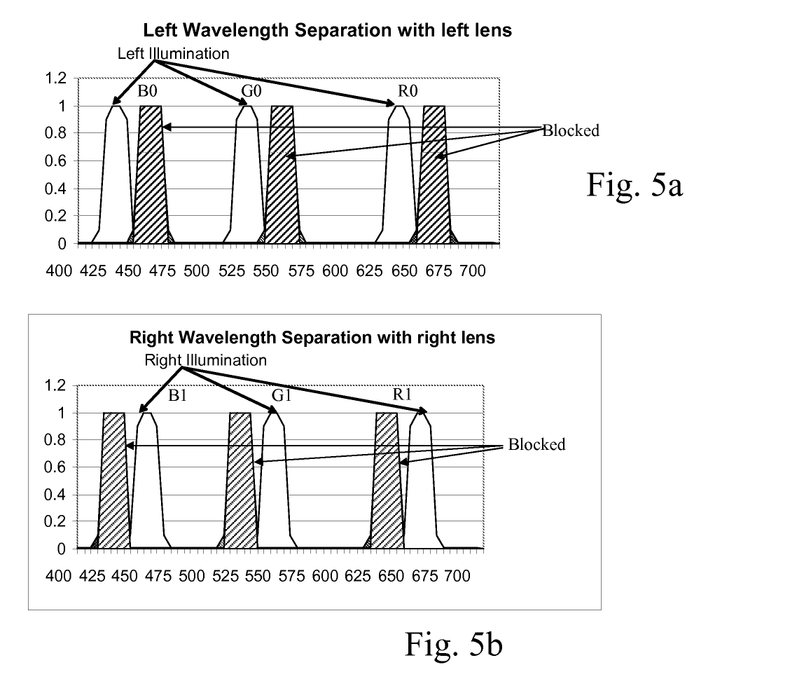

FIGS. 5a and 5b illustrate a third embodiment for selectively blocking light wavelengths in the left and right lenses 22₀ and 22₁. In this embodiment, only the range of wavelengths associated with the opposite lens are filtered; all other wavelengths are passed. Hence, for lens 22₀, only the wavelengths within a range of ±10 nm of R1, G1 and B1 are filtered out, while all other wavelengths are passed. Similarly, as shown in FIG. 5b, for lens 22₁, only the wavelengths within a range of ±10 nm of R0, G0 and B0 are filtered out, while all other wavelengths are passed.

This embodiment has the advantages that (1) only three wavelength ranges are filtered out, thus simplifying the fabrication of the lenses and (2) most wavelengths are passed, which will cause the least effect on the viewers perception of light apart from the display device. Thus, the viewer does not need to remove the lenses in order to see other things in the viewing room, and will not be distracted by object in the room that happen to fall into one of the discrete wavelength ranges used by the light sources.

It should be noted that in 5a-b, if lasers were used for the light sources to provide very small wavelength bandwidths, the lenses could be designed to block very small wavelength ranges, so that the lenses would appear to the viewer to be virtually transparent across the visible wavelength spectrum.

FIG. 6 illustrates the color spaces for the left and right images within a CIE xy chromaticity diagram. The CIE xy chromacity chart defines colors independent of brightness (i.e., white and grey have the same chromacity, but different brightness levels). The values x and y are calculated from tristimulus values X, Y and Z, which roughly correspond to blue, green and red.

A given pixel word, which provides values for the R, G and B component (or other set of colors) will produce one point (P0) on the chromacity chart using one set of primary colors (i.e., R0, B0 and G0) and another point (P1) using a second set of primary colors (i.e., R1, B1 and G1). Thus, the right and left images will vary slightly if uncorrected. It should be noted that the variation in chromacity between the points is exaggerated for purposes of illustration.

However, points from one color space can be mapped to the other color space in various ways. First, desaturation can be used to match colors and whitepoints between two color spaces. Using desaturation, a light at one wavelength (e.g., G1) is supplemented with relatively small amounts of light at other wavelengths (e.g. R1 and/or B1) from the same set of light sources in order to change the location of a point in color space. As shown in FIG. 6, when G1 is desaturated, it effectively is at light source at G2. Since G2 is created from component colors G1, R1 and B1, it will pass through lens 22₁. The amount of desaturating light could be controlled by the signal processing 16. The common color space defined by R2, G2 and B2 would be used to generate the images. Desaturation is discussed in greater detail in U.S. Pub. No. 2006/0044520, referenced above.

Alternatively, a pixel word may be mapped to another color space by changing the values of the pixel word in signal processing 16. For example, a pixel word [r, g, b] could be modified in the right eye image to [r+Δr, g+Δg, b+Δb], where Δr, Δg and Δb are adjustments determined by signal processing 16.

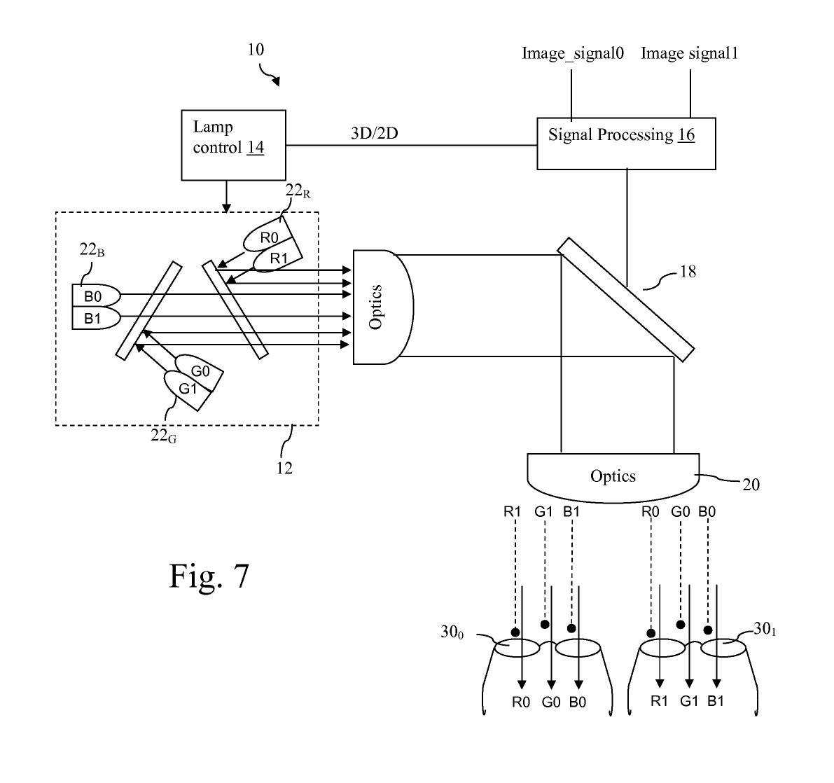

FIG. 7 illustrates a variation of the present invention, wherein two viewers are able to different videos on a single display. This embodiment is similar to that of FIG. 1, except each viewer wears glasses 30 (individually referenced as glasses 30₀ and 30₁) with both right and left lenses set to pass and block the same wavelengths. Thus, in FIG. 7, both lenses of glasses 30₀ pass wavelengths R0, G0 and B0 and block wavelengths R1, G1 and B1. Similarly, both lenses of glasses 30₁ block wavelengths R0, G0 and B0 and pass wavelengths R1, G1 and B1.

In operation, signal processing receives two different video sources, image_signal0 and image_signal1. Image_signal0 is displayed using the set of R0/G0/B0 wavelengths and image_signal1 is displayed using the set of R1/G1/B1 wavelengths. Video frames of image_signal0 will be received through glasses 30₀ and will be blocked by glasses 30₁. Video frames of image_signal1 will be received through glasses 30₁ and will be blocked by glasses 30₀. Thus, each viewer will only see one video signal, even though the display is alternately displaying both video signals.

This embodiment allows the display to show two different video streams (or more with additional sets of component colors) to different viewers. Hence, one viewer could be watching a television show while other viewers are watching a DVD movie or playing a video game. The television could have multiple audio sources to supply separate headphones with the appropriate audio signal.

While the present invention has been described in connection with a DMD driven display, it should be noted that the invention could be used with any display technology capable of producing a color gamut from two distinct sets of colors. For example, LCD (liquid crystal display) and LCOS (liquid crystal on silicon) technologies could be used to produce left and right eye images using separate primary color sets. Also, while the invention has been described in connection with a RGB systems, other color display systems, including display systems using more than three different colored light sources, could be used with the present invention.

Also, while the present invention has been discussed in connection with alternating images using different color sets, it should be noted that an embodiment using two SLMs 18, one illuminated by R0, G0 and B0 and the other illuminated by R1, G1 and B1 could be used to simultaneously project left and right images. When used in mono mode, only one SLM would be employed.

The present invention provides significant advantages over the prior art. First, the three dimensional images produced by the present invention should be high quality with little crosstalk. Second, the lenses that separate the left and right images should be similar in size and weight to normal glasses and, therefore, comfortable to wear for extended periods. The lenses can be placed over normal prescription eyewear as well. Third, the lenses can be made using existing technology and should be relatively inexpensive with mass production. Fourth, the general design of the display device can be almost the same as existing devices, with the addition of a second set of light sources. Fifth, the system could be made compatible with existing three dimensional videos using alternating field technology. Sixth, the display system is capable of displaying 3D video at lower frame rates than other 3D systems, with less flicker. Seventh, the display device is completely compatible with normal two dimensional video.

Although the Detailed Description of the invention has been directed to certain exemplary embodiments, various modifications of these embodiments, as well as alternative embodiments, will be suggested to those skilled in the art. The invention encompasses any modifications or alternative embodiments that fall within the scope of the Claims.

1. A method of displaying a three dimensional image comprising the steps of:
generating light from light sources having a first set of wavelengths to produce left eye images;
generating light from light sources having a second set of wavelengths different from the first set of wavelengths to produce right eye images; and
receiving the left eye images and right eye images through a pair of lenses, where a left eye lens passes the first set of wavelengths and blocks the second set of wavelengths and the right eye lens passes the second set of wavelengths and blocks the first set of wavelengths.

2. The method of claim 1 wherein each set of wavelengths includes at least three different wavelengths.

3. The method of claim 1 wherein the light sources are LEDs.

4. The method of claim 1 wherein the light sources are lasers.

5. The method of claim 1 wherein the step of generating light from light sources having the first set of wavelengths to produce left eye images and the step of generating light from light sources having the second set of wavelengths different from the first set of wavelengths to produce right eye images are performed concurrently.

6. The method of claim 1 wherein each set of wavelengths include red, green and blue wavelengths.

7. The method of claim 1 and further comprising the step of mapping colors from a first color space defined by the one of the sets of wavelengths to a second color space defined by the other of the sets of wavelengths by desaturation.

8. A display system comprising:
light sources for generating a first set of wavelengths to produce left eye images;
light sources for generating a second set of wavelengths to produce right eye images;
a spatial light modulator (SLM) for selectively directing light from the light sources to a viewer; and
a pair of lenses including a left eye lens that passes the first set of wavelengths and blocks the second set of wavelengths and a right eye lens that passes the second set of wavelengths and blocks the first set of wavelengths.

9. The display system of claim 8 and further including signal processing circuitry for adjusting frame data depending upon whether an image is directed to the viewer's left eye or right eye.

10. The display system of claim 8 wherein each set of wavelengths includes at least three different wavelengths.

11. The display system of claim 10 wherein the at least three different wavelengths include red, blue and green wavelengths.

12. The display system of claim 8 wherein the SLM is a deformable mirror device.

13. The display system of claim 8 wherein the light sources are lasers.

14. The display system of claim 8 wherein the light sources are LEDs.

15. The display system of claim 8 and further comprising a signal processor for controlling the light sources and SLM.

16. The display system of claim 15 wherein the signal processor adjusts frame data for an image depending upon whether the image will be displayed using the first set of wavelengths or the second set of wavelengths.

17. The display system of claim 8 wherein the signal processor concurrently displays frame data for a left eye image and for a right eye image by alternating bit-planes associated with successive frames.

18. The display system of claim 8 and further comprising circuitry for mapping colors from a first color space defined by the one of the sets of wavelengths to a second color space defined by the other of the sets of wavelengths by desaturation.

19. A viewing device for receiving a three dimensional video, comprising:
a left lens for receiving left eye images, where the left lens passes a first set of three or more disparate wavelengths and blocks a second set of three or more disparate wavelengths; and
a right lens for receiving right eye images, where the left lens passes the second set of wavelengths and blocks the first set of wavelengths.

20. The viewing device of claim 19 wherein the left eye lens blocks ranges of wavelengths between wavelengths of the first set of wavelengths and the right eye lens blocks ranges of wavelengths between wavelengths of the second set of wavelengths.

21. The viewing device of claim 19 wherein the left eye lens blocks the wavelengths used to generate images for the right eye and the right eye lens block the wavelengths used to generate images for the left eye.

22. A method of displaying a two or more video streams through a single display, comprising:
generating light from light sources having a first set of wavelengths to produce a first video stream;
generating light from light sources having a second set of wavelengths different from the first set of wavelengths to produce a second video stream; and
receiving the first video stream through a first pair of lenses which passes the first set of wavelengths and blocks the second set of wavelengths receiving the second video stream through a second pair of lenses that passes the second set of wavelengths and blocks the first set of wavelengths.

23. A display system comprising:
light sources for generating a first set of wavelengths to produce a first video stream;
light sources for generating a second set of wavelengths to produce a second video stream;
a spatial light modulator (SLM) for selectively directing light from the light sources to a viewer; and
a first pair of lenses for receiving the first video stream which pass the first set of wavelengths and block the second set of wavelengths receiving the second video stream and a second pair of lenses that pass the second set of wavelengths and block the first set of wavelengths.
